(19) United States
(12) Patent Application Publication
(10) Pub. No.: US 2005/0042451 A1
(43) Pub. Date: Feb. 24, 2005

(54) Magnet wire for motors coupled to speed variators of improved resistance to voltage peaks and manufacturing process of the same

(76) Inventor: Alejandro Rafael Chio Arjona, Queretaro (MX)

Correspondence Address: Law Office of Carmen Pili Ekstrom, 727 Sunshine Dr, Los Altos, CA, 94024, US

(21) Appl. No.: 10/956,969

(22) Filed: Sep. 30, 2004

Related U.S. Application Data
(63) Continuation-in-part of application No. 09/460,099, filed on Dec. 13, 1999, now abandoned.

(30) Foreign Application Priority Data
Jul. 19, 1999 (MX) 996700

(51) Int. Cl. H02P 5/46

(52) U.S. Cl. 428/375

(57) ABSTRACT

An improved magnet wire for motors coupled to speed controllers with higher resistance to voltage peaks and its manufacturing process, which is a 200° C. thermal class product with copper or aluminum conductor, with an insulating system of polyesterimide polymers and overcoat of modified amideimide, subject to a voltage pulse test of: Sample: twisted pair; frequency 20,000 Hz; voltage 2,300 volts; loading cycle 50%; temperature 180° C., rising speed 40 nanoseconds; pulse width 25 microseconds, being the product characterized by useful life more than 100 times longer than the one of the normal 200° C. class magnet wire.

This application is a continuation in part of U.S. patent application Ser. No. 09/460,099 filed on Dec. 31, 1999, and is herein in its entirety incorporated by reference.

### BACKGROUND OF THE INVENTION

The present invention relates to an improved magnet wire, especially to an improved magnet wire which is highly resistant to repetitive or pulse high voltage peaks or waves.

Several types of frequency variators or pulse/width modulators (PWM) and/or adjustable speed inverters in alternating current motors and their effects on the operation of the motor are known, The PWM controllers. present significant and transitory harmonics that can alter the performance characteristics of the motor and its life expectancy. The effects of maximum voltage, rise speed, frequency change, resonance and harmonics have been identified.

The PWM inverter is one of the newest and fastest of the emerging technologies of the non-linear equipment used in motor control systems. The reason for using PWM inverters, instead of the conventional AC and mechanical adjustable speed controls is to control the speed of an AC motor without torque losses. With stronger emphasis on energy savings and cost reduction, the use of higher performance PWM controller has increased exponentially. However, it has been found that these PWM controllers produce premature failure of the insulating system of the magnet wire in said motors.

It is thus highly desirable to provide an improved magnet wire for use in AC motors having PWM controllers.

It is also highly desirable to provide an improved magnet wire with a major resistance to the degradation caused by voltage pulse waves.

The basic stresses acting upon the stator and rotor windings can be separated in mechanical, dielectric and environmental terms. Said stresses are increased by of the voltage, the wave shape and the frequency, which affect the winding duration and the integrity of the whole system. During the initial phases of applying voltages, wave shapes and frequencies to AC motors, the main analysis focused on the thermal stresses generated by undesired harmonics of the controller that pass through the motor with the corresponding heat generation, and the increased heat generated by a smaller cooling capacity at lower speeds.

While more attention has been focused on the shape of the rotor than on the voltage resistance capacity of the rotor insulation, because the rotor influences the motor torque-speed characteristic, the current technology of the controllers, that use higher changeover speed (sometimes known as transport frequencies) focuses on the analysis of the insulating system of the stator winding.

The magnet wire normally used by motor manufacturers is typically a class H magnet wire. According to the ANSI/NEMA standards for magnet wire, under ideal conditions said wire is able to support 5,700 volt voltages with a rising time not above 500 volts/sec. However, it has been found that using standard controller technology, a magnet wire may have to support voltage waves of up to 3,000 volts, the voltage rising from 1.0 KV up to about 100 KV per microsec. frequencies from 1 KHz up to 20 KHz, and temperatures approaching 300° C. during short periods of time. It has also been found that, under certain circumstances, a wave is reflected to reinforce the voltage primary wave in successive turns, producing time fronts that exceed 3 microseconds in the subsequent turns.

These values are based on the supposition that the wire film will be applied concentrically to the conductor and that there is no film thickness increase in the manufacturing process or in the operation of the motor at high temperatures or that the bonding stress between the turns can decrease significantly. Thus, the movement and abrasion of the winding that reduce the thickness of the insulation between the turns can cause a premature failure of the insulation.

To address this problem U.S. Pat. No. 5,664,095, proposed a magnet wire is described that is resistant to voltage undulatory pulses, that comprises: a conductor, covered with an insulating material cover, with an effective number of particles, of 0.005 to 1 micron, of a material that resists said voltage undulatory pulses to be evaluated at 20 KHz.

### BRIEF DESCRIPTION OF THE DRAWING

FIG. 1 is a magnet wire sectional view showing the layers that cover the core metal conductor.

### DESCRIPTION OF THE INVENTION

It is thus an object of the present invention to provide a magnet wire that can support voltage waves of up to 3000 volts, with rising times of at least 100 KV per microsecond, and temperature increase of 300° C., frequencies of at least 20 KHz after the insertion of the windings on the rotor and stator of the motor, under normal temperature conditions during the expected lifetime.

Another object of the present invention is to provide an improved magnet wire that fulfils ANSI/NEMA MN 100 standards, as well as parts 30 and 31 of ANSI/NEMA MGI developed for constant-speed motors in a sinusoidal bus and for general purpose induction motors used with frequency controllers or both, for motors fed with defined purpose inventers, respectively.

Several researches to determine with higher precision the voltage resistance level of the currently proposed insulating system indicate preliminarily that the transient voltage levels combined with the operation temperatures of the motors can exceed the initial levels of the corona effect.

Some researchers have blamed the corona effects for the insulation failures in motors with frequency variators, PWM and/or inverters. Others have discarded the corona effect as the cause because the failures occurred in parts of the winding where the electric field is low. It is known that conventional enamels degrade when they are exposed to high voltage discharges, and the corona formed is discharged between adjacent coils of the motor insulation. Because of the gaps, and because of the air ionization due to the high voltage in the spaces of the rotor and stator coils, it has been found that the insulation failure in motors controlled by frequency variators, PWM and/or inverters is not mainly an insulation degradation mechanism by the corona effect. The magnet wire failure due to aging conditions caused by corona effect can be distinguished from the magnet wire failure due to aging conditions caused by voltage peak waves. The aging conditions caused by corona effect occurred in presence of a gas (usually air in the gaps of the coils) in localized positions of high electric stresses(AC or DC) strong enough to break or ionize the gas, to produce a large number of electrons or ionic energy that break the polymer chains or activate chemical reactions through ionic radicals. The corona effect discharge is a “cold discharge” and the temperature is not usually an important factor. The wire failure due to aging caused by corona effect is a long term process.

On the contrary, magnet wire failure due to aging caused by voltage peak waves does not need the presence of a gas medium. Instead repetitive voltage peak waves that show shorter rising times and smaller ratio voltage (high/rising) time, high pulse frequencies, and high energy momentum, together with high temperatures generated by them, are need to cause these failures. Upon having high voltages and minimum rising times, the failure through voltage peak waves can occur relatively fast and it is considered that it is the main cause of failures in motor controlled by frequency variators, PWM and/or inverters.

The applicant has developed an improved magnet wire that fulfils the performance characteristics desired by motor manufacturers for rotor and stator coils that are used under conditions of corona effect discharge.

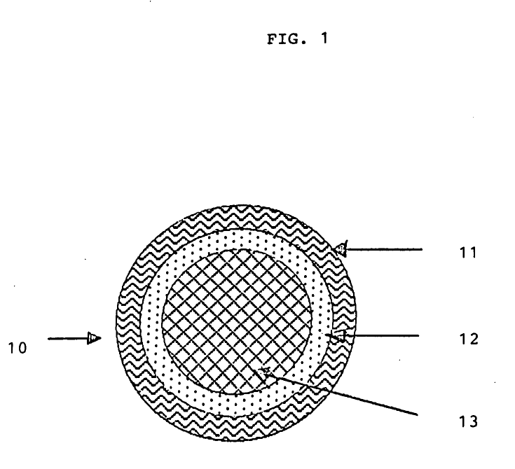

The magnet wire 10 ULTRANEL™ as shown in FIG. 1 is a 200° C. thermal class product with copper or aluminum metal conductor 13, and an insulation system 12 based on polyesterimide polymers with amideimide overcoat 11.

The wire fulfils NEMA MW-1000 standard, 35-C and a voltage pulse test not yet standardized by NEMA. The pulse test herein, employed a 40 nanosecond rising speed.

The amideimide overcoat is modified to withstand the conditions of the pulse test.

The conditions under which the voltage pulse test is conducted are as follows:
Sample: Twisted pair
Frequency 20,000 Hz
Voltage: 2,300 volts
Loading cycle: 50%
Temperature: 180° C.
Rising speed: 40 nanoseconds
Pulse width: 25 microseconds

The results obtained under these conditions show that wire 10 ULTRANEL™ has a working life of more than 100 times the life of traditional 200° C. class magnet wire in motor coils coupled to frequency variators.

The manufacture of ULTRANEL™ magnet wire requires the use of insulating materials with improved characteristics in mechanical and thermal properties period. Consequently the cover layer has been modified to withstand high temperature, corona effect and the presence of ozone that are generated during the voltage undulatory pulses occurring during the pulse test. The base coat was also altered to fulfill the requirements of flexibility, which was lowered because of the modification made on the overcoat.

The overcoat 11 is made from an amideimide resin modified through the incorporation of titanium dioxide and silica. The amideimide resin modified with titanium dioxide and silica used as overcoat is commercially available such as sold by P D George under the brand name Tritherm 982DX.

The amount of silica and metal oxide in the amideimide resin is variable. It depends upon the thickness of the overcoat compared to the thickness of the base coat, The optimum concentration of the metal oxide and silica is one that would permit the magnetic wire to resist voltage pulses of up to 41,600 seconds.

The base coat 12 consists of a polyesterimide resin modified with a high flexibility and high thermal resistance polyglycolylurea resin.

The polyesterimide resin is commercially available as Teramide 13097 from P D George Co, Isonel 200 from Schenectady and E-3538 from Heberts A G. The polyesterimide resin is modified with polyglycolylurea, also known as polyhydantoin by simply mixing to homogeneity the polyglycolylurea with the polyesterimide resin.

The invention is also characterized because of the critical thickness ratio between the two layers, since it strongly affects the voltage pulse resistance results. The best values are preferably obtained when the overcoat represents at least about 35% of the insulation total thickness is the combined thickness of the polyesterimide base coat and the amideimide overcoat. However, in order to obtain good property behavior at 180° C., slightly higher percentages are preferably required (from about 40 to about 50%), as shown in Experiment 5 below. The copper or aluminum core wire can be of various gauges. The thickness of the base coat 12 preferably depends upon the gauge of the conductor core wire 13. The thickness of the overcoat, in turn, depend upon its % over the total thickness and performance criteria that the resulting wire should resist voltage pulses of up to 41,600 seconds.

Manuacturing Procedure

ULTRANEL™ magnet wire is manufactured according to the following steps:

A copper wire is passed in a horizontal or vertical enameling oven. Said copper wire is first annealed in an oven with inert atmosphere to obtain the elongation corresponding to it. The copper wire enters the varnish application section where it receives an application of modified base varnish. It then immediately passes through the high temperature sections of the oven where the solvents evaporate and where the varnish resins polymerize. The wire is cooled and then returned again to the varnish application section, this process being repeated till the desired thickness of the base layer 12 is obtained.

When the desired thickness of the base layer is reached, the wire is returned to the varnish application section to receive the modified varnish resisting to the voltage pulse and frequency test. A desired thickness is preferably about 55 to about 69% of the total insulation of an insulating base coat. A desired thickness is preferably about 31% to about 44% of the total insulation of an amideimide resin overcoat varnish. A desired thickness is necessary to obtain an effectively improved magnet wire which is highly resistance to repetitive or pulse high voltage peaks or waves. The amideimide is incorporated with titanium dioxide and silica to withstand resistance to factors selected such as high temperature, corona effect, presence of ozone during voltage undulatory pulses, voltage pulse and frequency test.

The varnish application process is repeated until the desired thickness of the outer insulating layer 11 is obtained.

Finally, the magnet wire is wound on reels for use. The base layer varnish can be of any type, but in this case it is a modified polyesterimide type varnish with 10% to 50% of highly flexible and thermally resistant polyglycolylurea type resin preferably one sold by Condumex Installations, Polyglycolylurea is also sold by Bayer AG. The outer layer varnish is of the amideimide type modified with metal oxide.

### EXAMPLES

In the following experiments, which are shown in the table, different percentages used for the insulation thickness of an 18 AWG heavy magnet wire are described, but of course it can also be applied to other wire gauges.

| | | % of cover | Flexibility | Resistance |
|---|---|---|---|---|
| Experi- | Base | overcoat in | at 20% | at voltage |
| ment | varnish | the thickness | 3 φ | pulses (sec) |
| 1 | Polyesterimide | 20 | 100% | 650 |
| 2 | Polyestermimide | 30 | 90% | 8,300 |
| 3 | Polyesterimide | 40 | 85% | 17,500 |
| 4 | Polyesterimide | 40 | 100% | 19,700 |
| | (modified) | | | |
| 5 | Polyesterimide | 50 | 100% | 41,600 |
| | (modified) | | | |
| 6 | Polyesterimide | 20 normal | 100% | 300 |
| | | Al overcoat | | |

The polyesterimide varnish is modified with a polyglycolylurea resin in concentrations preferably ranging from about 10 to about 50%, more preferably preferably within the range of about 20 to about 35% according to the gauge of the wire to be manufactured. The polycolylurea resin concentration can be about 20% to about 35% of the mixture of polyesterimide and polycolylyurea, based on total solids. The polyglycolylurea resin provides improved flexibility properties, which permits to recover the decrease of said property through the effect of the overcoat varnish loaded with metal oxides.

Experiments: 1 to 3 shows how flexibility is lost through the increase of the overcoat thickness. In experiment 4, it is shown that, with polyglycolylurea-modified polyesterimide, the initial flexibility values are covered, allowing also to reach higher voltage pulse resistance values.

Experiment: 6 show the resistance to the voltage pulse test of a typical wire that has not been modified with the base coat and overcoat, of this invention.

The increase of the expected wire useful life, under the voltage pulse conditions present in situations where the speed of a motor is controlled through a frequency variator, is (41,600/300=)138 times.

### Table of Thickness Used for Magnet Wire Resistant to Voltage Peacks (In Inches)

| | | | | | Diameter | | % Overcoat | | |
|---|---|---|---|---|---|---|---|---|---|
| Gauge | Diameter Cu | | Diameter Base | | Final | | thickness | | Gauge |
| AWG | min | max | min | max | min | max | min | max | AWG |
| 24 | 0.0199 | 0.0202 | 0.0213 | 0.0217 | 0.0221 | 0.0224 | 32.9% | 37.6% | 24 |
| 23 | 0.0224 | 0.0227 | 0.0239 | 0.0243 | 0.0247 | 0.0250 | 31.5% | 35.9% | 23 |
| 22 | 0.0250 | 0.0254 | 0.0265 | 0.0270 | 0.0274 | 0.0278 | 34.3% | 38.6% | 22 |
| 21 | 0.0282 | 0.0286 | 0.0297 | 0.0302 | 0.0307 | 0.0311 | 37.0% | 41.0% | 21 |
| 20 | 0.0317 | 0.0322 | 0.0333 | 0.0339 | 0.0344 | 0.0349 | 38.0% | 41.7% | 20 |
| 19 | 0.0355 | 0.0361 | 0.0371 | 0.0378 | 0.0383 | 0.0389 | 40.2% | 43.8% | 19 |
| 18 | 0.0399 | 0.0405 | 0.0416 | 0.0423 | 0.0429 | 0.0435 | 40.9% | 44.2% | 18 |
| 17 | 0.0448 | 0.0455 | 0.0467 | 0.0475 | 0.0479 | 0.0486 | 36.2% | 39.5% | 17 |
| 16 | 0.0503 | 0.0511 | 0.0524 | 0.0533 | 0.0536 | 0.0544 | 34.0% | 37.1% | 16 |
| 15 | 0.0565 | 0.0574 | 0.0586 | 0.0596 | 0.0598 | 0.0607 | 34.0% | 37.0% | 15 |
| 14 | 0.0635 | 0.0644 | 0.0658 | 0.0668 | 0.0671 | 0.0680 | 33.9% | 36.7% | 14 |
| 13 | 0.0713 | 0.0724 | 0.0733 | 0.0745 | 0.0744 | 0.0755 | 32.7% | 36.0% | 13 |
| 12 | 0.0800 | 0.0812 | 0.0821 | 0.0834 | 0.0833 | 0.0845 | 33.8% | 36.8% | 12 |
| 11 | 0.0898 | 0.0912 | 0.0920 | 0.0935 | 0.0932 | 0.0946 | 32.8% | 35.7% | 11 |

The above-described invention is considered a novelty and scope is limited only by the following claims.

1. A magnet wire for motors coupled to speed variators of improved resistance to voltage peaks of 200° C. thermal class type, comprising:
a copper or aluminum conductor core;
a desired thickness of an insulating base coat varnish comprising a mixture of polyesterimide and polyglycolylurea covering the conductor core, and a desired thickness of an amideimide resin overcoat varnish, the thickness is at a combined thickness of the base coat varnish and the amideimide overcoat varnish, the amideimide resin modified through the incorporation of titanium dioxide and silica metal oxides to withstand high temperature, corona effect and presence of ozone during voltage undulatory pulses.

2. The magnet wire according to claim 1 wherein the thickness is about 55% to about 69% of the total insulation of an insulating base coat.

3. The magnet wire according to claim 1 wherein the thickness is about 31% to about 44% of the total insulation of an amideimide resin overcoat varnish.

4. The magnet wire according to claim 1 wherein the thickness selected are applied to gauges of from about 11 to about 24 AWG.

5. The magnet wire according to claim 1 wherein the insulating polyesterimide base coat is modified with a high flexibility and high thermal resistant polyglycolylurea resin.

6. The magnet wire according to claim 5, wherein the polyglycolylurea resin concentration is about 10% to about 50% of the mixture of polyesterimide and polyglycolylurea.

7. The magnet wire according to claim 5, wherein the polyglycolylurea resin concentration is about 20% to about 35% of the mixture of polyesterimide and polyglycolylurea, based on total solids.

8. The magnet wire according to claim 1, wherein the insulating polyesterimide base coat and the amideimide overcoat combine to form 100% of total insulating varnish thickness.

9. The magnet wire according to claim 8 wherein the thickness of the amideimide overcoat is at least about 35% of the total thickness.

10. The magnet wire according to claim 9 wherein the thickness of the amideimide overcoat is about 30% to about 45% of the total thickness.

11. The magnet wire according to claim 1 wherein the desired thickness of the overcoat is one that permits the wire to resist voltage pulses of up to 41,600 seconds.

12. A process for manufacturing a 200° C. thermal class magnet wire that fulfills the NEMA MW-1000, 35-C standard for motor coupled to speed controllers of improved resistance to voltage peaks using a horizontal or vertical enameling oven, comprising the steps of:
a) annealing a copper or aluminum wire of various gauges with inert atmosphere to obtain a desired elongation;
b) applying a base coat of a mixture of polyesterimide and polyglycolylurea in a solvent to the annealed copper or aluminum wire by passing the wire in a varnish section of the oven, where in the polyester imide varnish is modified with polyglycolylurea resin in a concentration of from about 20% to about 35% based on total solids;
c) passing the base coated annealed wire to a high temperature section of the oven to evaporate the solvent and polymerize the base coat;
d) cooling the base coated annealed wire;
e) repeating steps b) to d) until a desired thickness of the base coat is achieved;
f) applying an overcoat of amideimide incorporated with titanium dioxide and silica to withstand resistance to factors selected from the group consisting of high temperature, corona effect, presence of ozone during voltage undulatory pulses, voltage pulse and frequency test;
by reintroducing the base coated annealed wire having the desired thickness of base coat into the varnish application section of the oven; and
g) repeating step f) until a desired thickness of overcoat is achieved.

13. The method according to claim 12 wherein the base coat is a polyesterimide resin varnish containing about 10% to about 50% polyglycolylurea depending upon the wire gauge, selected from about 11 to about 24 AWG.

14. The method according to claim 12 wherein the base coat is a polyesterimide resin varnish containing about 20% to about 35% polyglycolylurea.

15. The method according to claim 12 wherein the desired thickness of the overcoat is one that permits the wire to resist voltage pulses of up to 41,600 seconds.

16. The method according to claim 12 wherein the overcoat is an amideimide resin overcoat varnish, the amideimide resin modified through the incorporation of titanium dioxide and silica to withstand high temperature, corona effect and presence of ozone during voltage undulatory pulses.

17. The method according to claim 12 wherein the insulating polyesterimide base coat and the amideimide overcoat combine to form 100% of total insulating varnish thickness.

18. The method according to claim 12 wherein thickness of the amideimide overcoat is about 30% to about 45% of the total thickness.

19. The method according to claim 12 wherein the thickness of the amideimide overcoat is at least 35% of the total combined thickness of base coat varnish and amideimide overcoat varnish.

20. The method according to claim 12 wherein the desired thickness is about 55% to about 69% of the total insulation of an insulating base coat and about 31% to about 44% of the total insulation of an amideimide resin overcoat varnish.
